(19) United States
(12) Patent Application Publication
(10) Pub. No.: US 2009/0006393 A1
(43) Pub. Date: Jan. 1, 2009

(54) APPARATUSES, METHODS, AND COMPUTER PROGRAM PRODUCTS FOR MANAGING FILES BEING STORED IN A MEMORY

(75) Inventor: Mikko A. Nurmi, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/771,193

(22) Filed: Jun. 29, 2007

(51) Int. Cl. G06F 7/20; G06F 17/30

(52) U.S. Cl. 707/6; 707/E17.014; 707/E17.001

(57) ABSTRACT

A method is provided for interacting with files being stored in a memory. The method includes sequentially receiving characters into a series that at least temporarily designates at least part of a file name for a target file being stored in a memory. As the characters are sequentially received, a respective list of files stored in the memory that have file names that are related to a current version of the series are iteratively provided. The list of files can include at least one file having a file name that fails to include the current version of the series. Also provided are corresponding apparatuses and computer program products.

### FIELD OF THE DISCLOSURE

Embodiments of the present invention relate generally to apparatuses, methods, and computer program products for managing files, and to apparatuses, methods, and computer program products for interacting with files, such as by naming or renaming files, being stored in a memory.

### BACKGROUND

Current software applications and file management systems provide a variety of user interfaces associated with managing, locating, and saving files in a memory. However, issues remain with respect to locating the appropriate location to save files and assuring consistency between newly-named files (whether those files are being newly saved or have been previously saved and are being renamed) and other files located in the same file system and/or memory. In many cases, it is difficult to recall a precise naming convention for files that may have a group relationship, or it may be difficult to remember to what point file naming has proceeded within a serial file naming system.

As such, it would be desirable to provide an improved file naming system and method, both for naming newly stored files and for re-naming previously stored files. In particular, it would be desirable to provide an improved methodology for naming files while readily taking into the names of other files that have been previously named and stored.

### BRIEF SUMMARY

According to one aspect, a method is provided for interacting with files being stored in a memory. The method includes sequentially receiving characters into a series that at least temporarily designates at least part of a file name for a target file being stored in a memory. As the characters are sequentially received, a respective list of files stored in the memory that have file names that are related to a current version of the series are iteratively provided. The list of files can include at least one file having a file name that fail to begin with the current version of the series. The list of files may have file names that correspond to or are related alpha-numerically to the current version of the series, and the series may be incorporated into the list at an appropriate alpha-numeric position in the list. For example, a target folder stored in the memory may be selected for storing the target file, and a list of files stored in the target folder that have file names that are related to the current version of the series may be iteratively provided.

In some embodiments, the method may further include iteratively providing, as the characters are sequentially received, a respective list of folders stored in the memory that contain files having file names that correspond to the current version of the series. For example, the respective list of folders may contain files having file names including the current version of the series, and may be iteratively provided simultaneously with iteratively providing the list of files stored in the memory that have file names that correspond to the current version of the series. In some embodiments, the target file may exist in the memory prior to the receipt of the characters.

According to another aspect, an apparatus is provided that includes a processing device configured to sequentially receive characters into a series that at least temporarily designates at least part of a file name for a target file being stored in a memory. The processing device is further configured to iteratively provide, as the characters are sequentially received, a respective list of files that have file names that are related to a current version of the series. The list of files may include at least one file having a file name that fails to begin with the current version of the series.

According to yet another aspect, a computer program product is provided that includes a computer-readable storage medium having computer-readable instructions stored therein. The computer-readable instructions include first instructions for sequentially receiving characters into a series that at least temporarily designates at least part of a file name for a target file being stored in a memory. The computer-readable instructions also include second instructions for iteratively providing, as the characters are sequentially received, a respective list of files stored in the memory that have file names that are related to a current version of the series. The list of files may include at least one file having a file name that fails to begin with the current version of the series.

According to still another aspect, an apparatus is provided that includes first means for sequentially receiving characters into a series that at least temporarily designates at least part of a file name for a target file being stored in a memory. The apparatus also includes second means for iteratively providing, as the characters are sequentially received, a respective list of files stored in the memory that have file names that are related to a current version of the series. The list of files may include at least one file having a file name that fails to begin with the current version of the series.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flow chart representing a method for interacting with files stored in a memory in accordance with an embodiment of the present invention;

FIGS. 2A-2D are schematic views of a graphical user interface associated with a device carrying out a method in accordance with an embodiment of the present invention;

FIGS. 3A and 3B are schematic views of a graphical user interface associated with a device carrying out a method in accordance with an embodiment of the present invention;

FIGS. 4A and 4B are schematic views of a graphical user interface associated with a device carrying out a method in accordance with an embodiment of the present invention;

FIG. 5 is a block diagram schematically representing a memory;

FIGS. 6, 7A-7C, and 8A-8C are schematic views of a graphical user interface associated with a device carrying out a method in accordance with an embodiment of the present invention; and

FIG. 9 is a block diagram of an apparatus for interacting with a target file being saved in a memory in accordance with an embodiment of the present invention.

### DETAILED DESCRIPTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

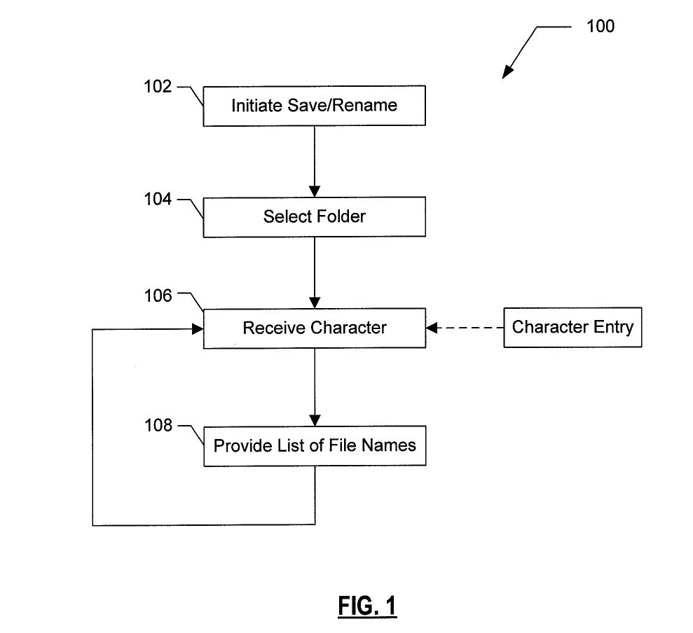

Referring to FIG. 1, therein is shown a flow chart representing a method 100 for interacting with files or folders being stored in a memory in accordance with an exemplary embodiment of the present invention. The embodiment will be described below in terms of file storage and management, with the understanding that the embodiment is equally applicable to folder storage/management, either separately or together with file storage/management operations. The memory may be either temporarily or permanently associated, for example, with a computer or the like, and/or may be distributed between various devices and/or geographic locations. At Block 102, an operation to save a file to the memory, or to rename a file already existing in the memory, may be initiated. The memory may or may not store other files, and to distinguish the file to be saved/renamed from other files that may exist in the memory, the file to be saved/renamed will be referred to as the “target file.” As such, reference herein to a target file being stored in memory includes both the initial naming and storage of a newly saved target file and the renaming of a previously stored target file. The memory may include various portions or folders for organizing files stored therein, and at Block 104 a specific folder, called the “target folder,” may be specified as that within which the target file is intended to be saved (in a renaming operation, the target folder may be the folder within which the target file already exists). Alternatively, no folder may be specified, a folder may be selected by other means, discussed later, or a file structure may be utilized that does not involve folders or the like.

At Block 106, one or more characters are received into a series to specify at least a portion, typically the initial portion, of a file name for the target file. For example, the characters may be received by a device associated with the memory after being entered via a user input device, such as, for example, a keyboard, keypad, softkeys, and/or a microphone. At Block 108, a list of files stored in the memory that have file names that are related to a current version of the series is provided. The actions corresponding to Blocks 106 and 108 are repeated as often as characters are sequentially received at Block 106, e.g., following the entry of each additional character to the series, such that for each occurrence of Block 108, a respective list of files stored in the memory that have file names that are related to a current version of the series is iteratively provided as the characters are sequentially received. In some embodiments, the iteratively provided list may contain both file names and folder names. In cases where a target folder is specified, the file names would be drawn from the target folder, and the folder names would be folders other than, and possibly including, the target folder.

For example, at a first time, an “a” may be received, such that the series consists of only “a”. A list may then be provided of files from the target folder that are related to the series “a” (the phrase “related to” is described further below). Subsequently, a “b” may be received, such that the series consists of “ab”, and a new list is then provided of files from the target folder that are related to the series “ab”. Next, a “cd” may be received together, the series now consisting of “abcd”, and a new iteration of a list is provided of files from the target folder that are related to the series “abcd”. In each case, the series may at least temporarily designate at least part of a file name for the target file, although the series ultimately chosen as the file name for the target file may be different from all prior series and may have any characters in common with any of the prior series. It should be noted that the term “character,” as used herein, refers to any perceptible indicator, and is not necessarily limited to standard alpha-numeric characters. For example, permissible “characters” may include Greek letters, non-textual symbols, and/or spaces or null characters. Further, the characters may result from a variety of actions, including keystrokes of a keyboard, sound received by a microphone, etc., any of which could result in the generation of “characters.”

As mentioned above, at Block 108, a respective list of files stored in the memory that have file names that are related to a current version of the series is iteratively provided as the characters are sequentially received. File names may be “related to” the series in a variety of manners, depending on the application. For example, file names may be related to a series through the fact that the file names correspond to files located in the target folder for which the series is being entered. Alternatively, or in addition, file names may be alpha-numerically related to a series, such as, for example, when the file names bear some alpha-numeric similarity to the series or when the file names are placed in alpha-numerical relationship to the series, or may correspond alpha-numerically to the series, such as, for example, when the file names begin with the series, end with the series, or include the series. Another possibility is that the file names are related to the series via some metadata associated with files corresponding to the file names. Generally, a list of file names is related to a series if there is some logical connection between the file names and the series that pervades the list. In some embodiments, this list of file names may include at least one file name that fails to begin with the current version of the series.

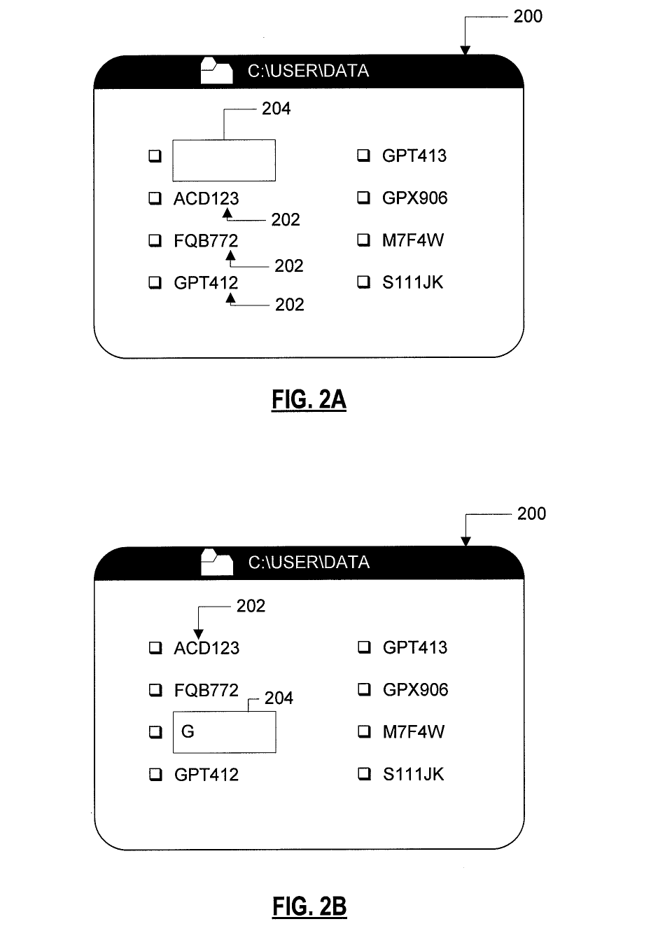

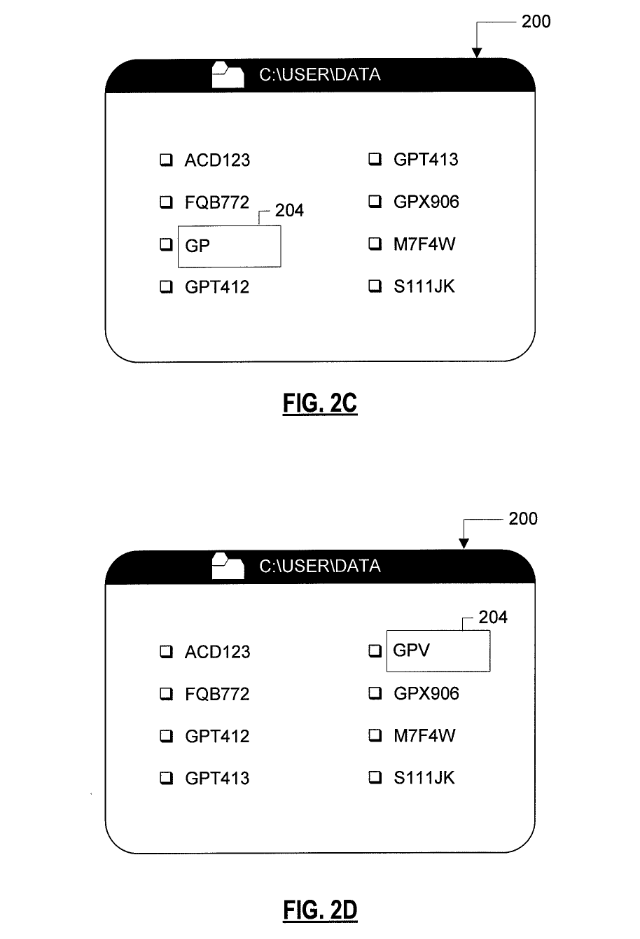

Several exemplary embodiments of the above-described method 100 are now provided. Referring to FIGS. 2A-2D, therein are shown views of a graphical user interface associated with a device carrying out an embodiment of the method 100. In FIG. 2A, a file saving process has been initiated for a target file, and a folder named “C:\USER\DATA” has been specified as the target folder, this indication being displayed at the top of a dialog box 200 showing the file names 202 of the files contained in that folder. A box 204 is provided for displaying characters received as part of the file name for the target file. However, no characters have yet been received for a file name for the target file. As such, the box 204 is displayed as empty, indicating that characters should be entered. The box 204, being empty, is placed at the beginning of the list of file names 202.

Subsequently, a “g” is entered and received, the “g” being displayed in the box 204. In response, the box 204 is placed in the list so that the associated series (i.e., “g”) is alphabetically ordered amongst the file names 202. As each subsequent character is entered and received for the file name for the target file, the box 204 is again located so that the associated series is alphabetically ordered with respect to the file names 202.

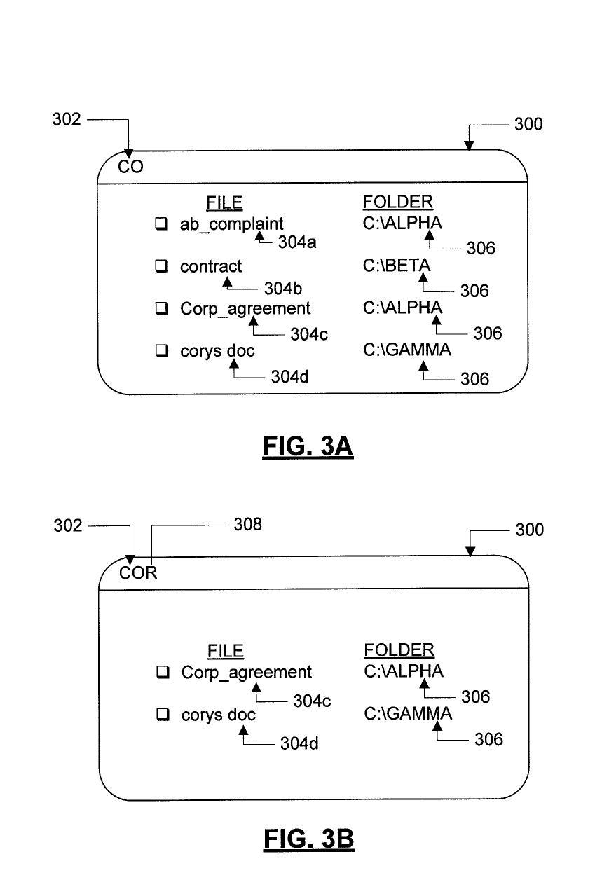

Referring to FIGS. 3A and 3B, therein are shown views of a graphical user interface associated with a device carrying out another embodiment of the method 100. In this case, a user may enter characters 302 (here the characters “co”) that are displayed towards the top of a dialog box 300. As a result, a list of file names 304a-d is displayed that each include the characters “co”. Folder designations 306 related to the storage locations of the respective files corresponding to the file names may also be provided. Subsequently, a user may enter another character 308 (here an “r”), and in response the list of file names 304c-d is updated to include only those files including “cor” in the file name.

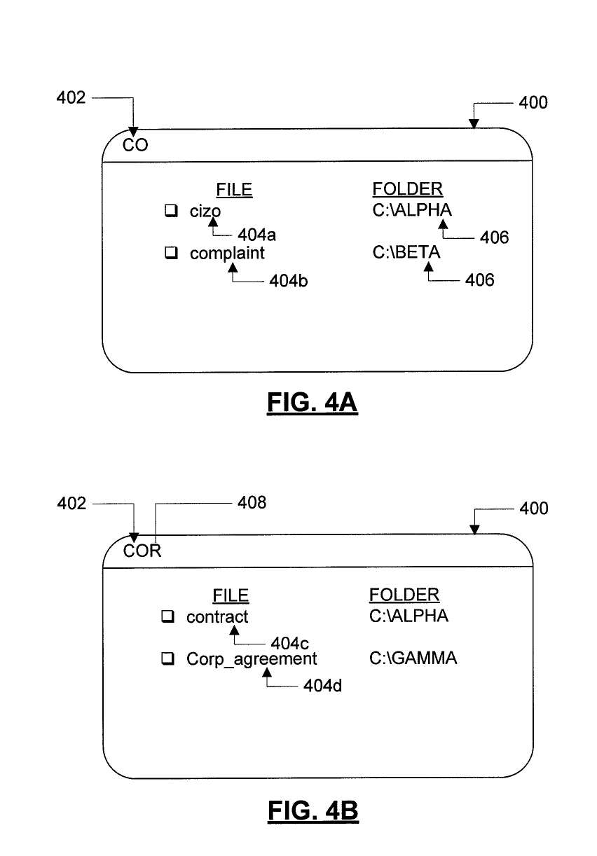

Referring to FIGS. 4A and 4B, therein are shown views of a graphical user interface associated with a device carrying out another embodiment of the method 100. In this case, a user may enter characters 402 (here the characters “co”) that are displayed towards the top of a dialog box 400. As a result, a list of file names 404a-b is displayed that alphabetically surround the characters “co”. Again, folder designations 406 related to the storage locations of the respective files corresponding to the file names may also be provided. Subsequently, a user may enter another character 408 (here an “r”), and in response the list of file names 404c-d is updated to include only those files alphabetically surrounding the series “cor”.

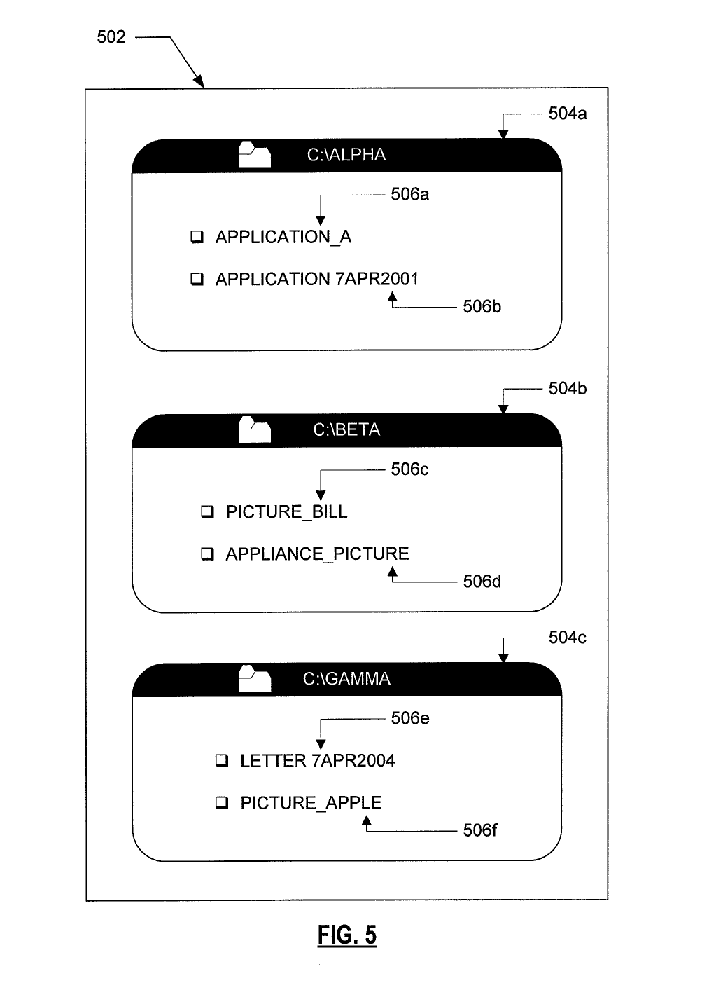

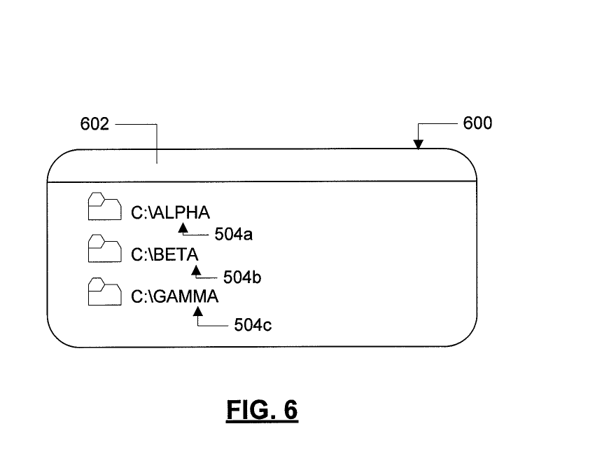

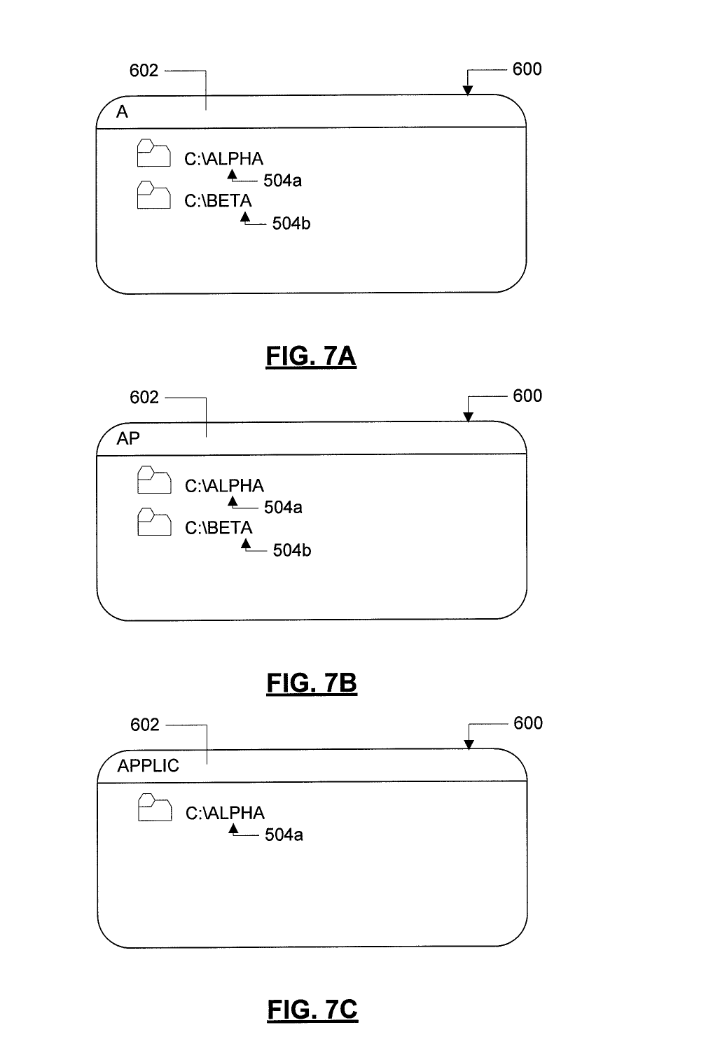

As another example, referring to FIGS. 5, 6, and 7A-7C, therein are shown a block diagram schematically representing a memory 502 and views of a graphical user interface associated with a device associated with the memory and carrying out another embodiment of the method 100, respectively. The memory 502 includes several folders, including the folder “C:\ALPHA” 504a, “C:\BETA” 504b, and “C:\GAMMA” 504c. The folders 504a-c contain various files 506a-f having file names as shown in the figure. A user may initiate a process to save a target file, at which time a dialog box 600 is provided that displays all of the folders 504a-c in a folder area 604. No file name characters have been entered for the target file, so the character area 602 of the dialog box 600 remains empty. Subsequently, the user enters an “a” (displayed in the character area 602) and a list of folders is provided that contain files having file names that begin with “a”, i.e., “C:\ALPHA” and “C:\BETA”. Next, the user enters a “p” such that the series of characters in the character area 602 is “ap”, and the folder area 604 remains unchanged, as the folders “C:\ALPHA” and “C:\BETA” both contain files having file names starting with “ap”. The user continues to enter characters until reaching the series “applic”, at which time the folder area 604 is updated to include the only folder having files with file names starting with the series “applic”, that being “C:\ALPHA”. that correspond to the current version of the series.

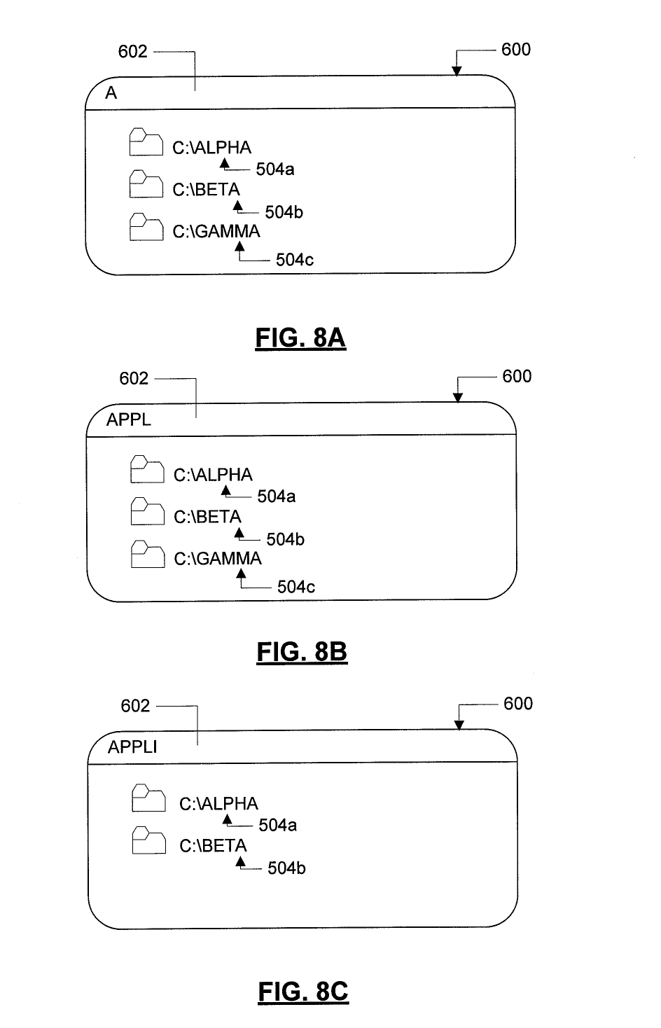

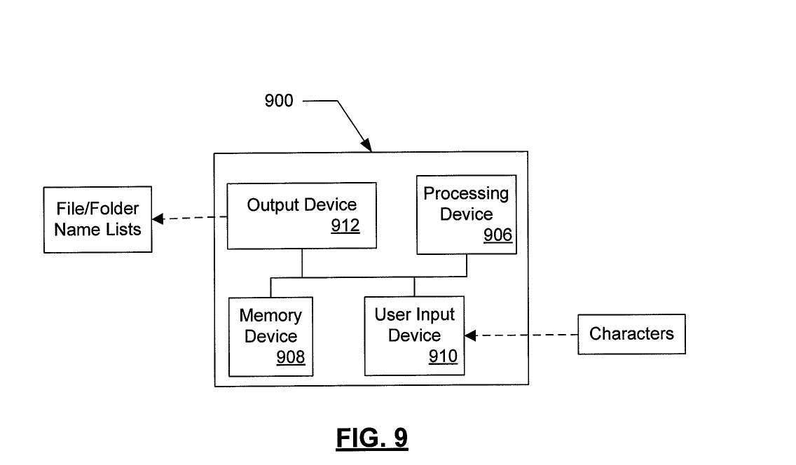

As another example, referring to FIGS. 5, 6, and 8A-8C, therein are shown a block diagram schematically representing a memory 502 and views of a graphical user interface associated with a device associated with the memory and carrying out another embodiment of the method 100, respectively. Again, a user may initiate a process to save a target file, at which time a dialog box 600 is provided that displays all of the folders 504a-c in a folder area 604. No file name characters have been entered for the target file, so the character area 602 of the dialog box 600 remains empty. Subsequently, the user enters an “a” (displayed in the character area 602) and a list of folders is provided that contain files having file names that include an “a”, i.e., “C:\ALPHA”, “C:\BETA”, and “C:\GAMMA”. Next, the user enters a “ppl” such that the series of characters in the character area 602 is “appl”, and the folder area 604 remains unchanged, as all of the folders contain files having file names containing “appl”. The user continues to enter characters until reaching the series “appli”, at which time the folder area 604 is updated to include the only folder having files with file names containing the series “appli”, that being “C:\ALPHA” and “C:\BETA”. While this and the previous examples are directed to cases in which folders are selected based on the inclusion of a current version of a sequentially received series in file names of files contained in the folders, other manners for choosing folders based on other relationships between the entered character series and the file names are also available, as discussed previously.

Referring to FIG. 9, therein is shown a block diagram of an apparatus 900 for interacting with a target file being saved in a memory. The apparatus includes first means for sequentially receiving characters into a series. The series may at least temporarily designate at least part of a file name for the target file being stored in the memory. The apparatus may also include second means for iteratively providing, as the characters are sequentially received, a respective list of files stored in the memory that have file names that are related to a current version of the series. For example, the first and second means may include a processing device 906, such as a microprocessor, an application specific integrated circuit (ASIC), and/or some other computing device, that is configured to sequentially receive the characters into the series and to provide, as the characters are sequentially received, the respective list of files. In one embodiment, the processing device 906 may be configured to provide the list of files so as to include at least one file having a file name that fails to begin with the current version of the series.

The processing device 906 may be further configured to accomplish any or all of the above described methods of file saving and/or management. For example, the processing device 906 may be configured to iteratively provide a list of files stored in the memory having file names that correspond or are related alpha-numerically to the current version of the series, and to incorporate the series into the list at an appropriate alpha-numeric position in the list. Further, the processing device 906 may be configured to provide, as the characters are sequentially received, a respective list of folders stored in the memory that contain files having file names that correspond to, e.g., include, the current version of the series. Additionally, the processing device may be configured to select a folder stored in the memory as the target folder for storing the target file and to iteratively provide a list of files stored in the target folder that have file names that are related to the current version of the series.

The apparatus 900 may further include a memory device 908 that is in communication with the processing device 906 and that includes or is otherwise integrated with the memory. Additionally, the apparatus 900 may include a user input device 910, such as a keyboard, that allows entry of characters for receipt by the processing device 906, and may also include an output device 912, such as a display, for providing lists of file names and folders in a perceptible manner.

As described above and as will be appreciated by one skilled in the art, embodiments of the present invention may be configured as a system, an apparatus, or a method. Accordingly, embodiments of the present invention may be comprised of various means including entirely of hardware, entirely of software, or any combination of hardware and software. Furthermore, embodiments of the present invention may take the form of a computer program product on a computer-readable storage medium having computer-readable program instructions (e.g., computer software) embodied in the storage medium, e.g., memory device 908. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processing device 906, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, although the above embodiments have described separately the provision of folder lists and file name lists, in some embodiment, file names and folders may be listed simultaneously, thereby possibly allowing users to search for files and folders in parallel. Alternatively, folder and file search processes can be conducted serially, such that a user may search for a specific folder, and then search that specific folder for a specific file. Also, while the above described embodiments have focused on file saving activities, the scheme disclosed herein could be utilized in facilitating the ordering of objects in any type of list. For example, when entering a new contact into an electronic address book, the position of the contact being added could be adjusted alphabetically within the existing list of contacts as characters representing the contact name are added. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
sequentially receiving characters into a series that at least temporarily designates at least part of a file name for a target file being stored in a memory; and
iteratively providing, as the characters are sequentially received, a respective list of files stored in the memory that have file names that are related to a current version of the series, the list of files including at least one file having a file name that fails to begin with the current version of the series.

2. A method according to claim 1, wherein said iteratively providing the list of files stored in the memory that have file names that are related to the series includes iteratively providing a list of files stored in the memory having file names that are related alpha-numerically to the current version of the series.

3. A method according to claim 2, wherein said iteratively providing the list of files stored in the memory having file names that are related alpha-numerically to the series includes incorporating the series into the list at an appropriate alpha-numeric position in the list.

4. A method according to claim 2, wherein said iteratively providing the list of files stored in the memory having file names that are related alpha-numerically to the current version of the series includes iteratively providing a list of files stored in the memory having file names that correspond alpha-numerically to the current version of the series.

5. A method according to claim 1, further comprising iteratively providing, as the characters are sequentially received, a respective list of folders stored in the memory that contain files having file names that correspond to the current version of the series.

6. A method according to claim 5, wherein said iteratively providing the list of folders stored in the memory that contain files having file names that correspond to the series includes iteratively providing, as the characters are sequentially received, a list of folders stored in the memory that contain files having file names including the current version of the series.

7. A method according to claim 5, wherein the respective list of folders is provided simultaneously with iteratively providing the list of files stored in the memory that have file names that correspond to the current version of the series.

8. A method according to claim 1, wherein the target file exists in the memory prior to said sequentially receiving characters.

9. A method according to claim 1, further comprising selecting a target folder stored in the memory for storing the target file, and wherein said iteratively providing the list of files stored in the memory that have file names that are related to the current version of the series includes iteratively providing a list of files stored in the target folder that have file names that are related to the current version of the series.

10. A method according to claim 1, further providing iteratively providing, as the characters are sequentially received, a respective list of folders stored in the memory that have folder names that are related to a current version of the series.

11. A method according to claim 10, wherein the respective list of folders is provided together with the respective list of files.

12. An apparatus comprising:
a processing device configured to sequentially receive characters into a series that at least temporarily designates at least part of a file name for a target file being stored in a memory and to iteratively provide, as the characters are sequentially received, a respective list of files that have file names that are related to a current version of the series, the list of files including at least one file having a file name that fails to begin with the current version of the series.

13. An apparatus according to claim 12, wherein said processing device is configured to iteratively provide a list of files stored in the memory having file names that are related alpha-numerically to the current version of the series.

14. An apparatus according to claim 13, wherein said processing device is configured to incorporate the series into the list at an appropriate alpha-numeric position in the list.

15. A method according to claim 13, wherein said processing device is configured to iteratively provide a list of files stored in the memory having file names that correspond alpha-numerically to the current version of the series.

16. An apparatus according to claim 12, wherein said processing device is further configured to iteratively provide, as the characters are sequentially received, a respective list of folders stored in the memory that contain files having file names that correspond to the current version of the series.

17. An apparatus according to claim 16, wherein said processing device is configured to iteratively provide, as the characters are sequentially received, a list of folders stored in the memory that contain files having file names including the current version of the series.

18. An apparatus according to claim 16, wherein said processing device is configured to provide the respective list of folders simultaneously with iteratively providing the list of files stored in the memory that have file names that correspond to the current version of the series.

19. An apparatus according to claim 12, wherein the target file exists in the memory prior to said sequentially receiving characters.

20. An apparatus according to claim 12, wherein said processing device is further configured to select a target folder stored in the memory for storing the target file and to iteratively provide a list of files stored in the target folder that have file names that are related to the current version of the series.

21. An apparatus according to claim 12, further comprising a memory device in communication with said processing device, the memory device including the memory.

22. A computer program product comprising a computer-readable storage medium having computer-readable instructions stored therein, the computer-readable instructions comprising:
first instructions for sequentially receiving characters into a series that at least temporarily designates at least part of a file name for a target file being stored in a memory; and
second instructions for iteratively providing, as the characters are sequentially received, a respective list of files stored in the memory that have file names that are related to a current version of the series, the list of files including at least one file having a file name that fails to begin with the current version of the series.

23. A computer program product according to claim 22, wherein said second instructions for iteratively providing the list of files stored in the memory that have file names that are related to the series include instructions for iteratively providing a list of files stored in the memory having file names that are related alpha-numerically to the current version of the series.

24. A computer program product according to claim 23, wherein said instructions for iteratively providing the list of files stored in the memory having file names that are related alpha-numerically to the series include instructions for incorporating the series into the list at an appropriate alpha-numeric position in the list.

25. A computer program product according to claim 23, wherein said instructions for iteratively providing the list of files stored in the memory having file names that are related alpha-numerically to the current version of the series include instructions for iteratively providing a list of files stored in the memory having file names that correspond alpha-numerically to the current version of the series.

26. A computer program product according to claim 22, further comprising third instructions for iteratively providing, as the characters are sequentially received, a respective list of folders stored in the memory that contain files having file names that correspond to the current version of the series.

27. A computer program product according to claim 26, wherein said third instructions for iteratively providing the list of folders stored in the memory that contain files having file names that correspond to the series includes instructions for iteratively providing, as the characters are sequentially received, a list of folders stored in the memory that contain files having file names including the current version of the series.

28. A computer program product according to claim 26, wherein said third instructions for iteratively providing the respective list of folders includes instructions for iteratively providing the respective list of folders simultaneously with iteratively providing the list of files stored in the memory that have file names that correspond to the current version of the series according to said second instructions.

29. A computer program product according to claim 22, wherein the target file exists in the memory prior to said sequentially receiving characters.

30. A computer program product according to claim 22, further comprising third instructions for selecting a target folder stored in the memory for storing the target file, and wherein said second instructions for iteratively providing the list of files stored in the memory that have file names that are related to the current version of the series includes instructions for iteratively providing a list of files stored in the target folder that have file names that are related to the current version of the series.

31. An apparatus comprising:
first means for sequentially receiving characters into a series that at least temporarily designates at least part of a file name for a target file being stored in a memory; and
second means for iteratively providing, as the characters are sequentially received, a respective list of files stored in the memory that have file names that are related to a current version of the series, the list of files including at least one file having a file name that fails to begin with the current version of the series.
